(19) United States
(12) Patent Application Publication
(10) Pub. No.: US 2011/0148572 A1
(43) Pub. Date: Jun. 23, 2011

(54) TOUCH-CONTROL LOCK

(75) Inventor: CHENG-KUN KU, Taipei County (TW)

(73) Assignee: BEST SOLUTION TECHNOLOGY INC., Taipei County (TW)

(21) Appl. No.: 12/758,263

(22) Filed: Apr. 12, 2010

(30) Foreign Application Priority Data
Dec. 18, 2009 (TW) 098143632

(51) Int. Cl. G06F 7/04; G06F 3/041; G06F 3/045; G06F 3/033

(52) U.S. Cl. 340/5.51; 345/173; 345/174; 715/863; 178/18.05

(57) ABSTRACT

A method for operating a touch-control lock system according to a gesture or a figure, comprising steps of: (a) sensing a designated gesture or figure while a user uses his finger touches a touch-control panel of the touch-control lock system and outputting an electronic signal according to the designated gesture or figure; (b) processing the electronic signal by a micro-control unit and judging whether or not the electronic signal is a valid input by the micro-control unit; (c) determining whether or not the designated gesture or figure is valid by the micro-control unit; (d) loading correct data for the designated gesture or figure stored in a touch-control instruction processing unit and comparing the correct data with the designated gesture so as to determine if the designated gesture or figure is valid; and (e) outputting a control command to an application apparatus to react correspondingly.

### FIELD OF THE INVENTION

The present invention relates to a touch-control lock for a gesture or a figure operation, more particularly to, a touch-control lock installed at a computer for serving the security purpose at booting the computer. The user must input a correct gesture or figure so as to unlock the touch-control lock, meanwhile, the user can easily remember the gesture or the figure so as to prevent his personal data being stolen. The technical content of the present disclosure can ensure the safety for computer data.

### BACKGROUND OF THE INVENTION

The touch panel originated from the 1970's. The U.S. Military authority develops the same so as to serve the military purposes. In the 1980's, the technologies related to the touch panel are transferred to civilians and further being developed to serve a plurality of purposes. In view of the conventional electronic computing apparatus, such as computers, the way for their inputs can be peripherals such as keyboards or mouse as input interfaces. However, the aforesaid peripherals are too huge for carriage and thus it is a barrier for the slim electronic products. Due to the great demand for the thin electronic devices, the touch panel is, in the portable information products, booming by gradually catching consumer's eyes. Additionally, the touch panel is applied to the personal portable information products, and widely spread to consumer products, public information, communication equipment, office automatic equipment, information collecting apparatus, industrial apparatus, and the like. Therefore, the research and development for the touch panel gradually plays a major role for the electronic industry.

Mostly, the ordinary touch-control devices are applied to switch purposes for the touch panel and consumer's electronics. Hence, they lack other applications.

### SUMMARY OF THE INVENTION

In view of the disadvantages of prior art, the primary object of the present invention relates to a touch-control lock installed at a computer for serving the security purpose at booting the computer. The user must input a correct gesture or figure so as to unlock the touch-control lock, meanwhile, the user can easily remember the gesture or the figure so as to prevent his personal data being stolen. The technical content of the present disclosure can ensure the safety for computer data.

Another object of the present invention relates to a replacement for the conventional dial or key-press safety box lock, which ensures better security for the conventional safety box lock.

Yet another object of the present invention relates to provide a disclosure to replace the ordinary residential or office key-press electronic lock with better security.

Yet another object of the present invention relates to serve the touch-control input command apparatus as electronic toys such as electronic dog, electronic dinosaur and the like as well as the superior advantage such as easy command inputs.

Yet another object of the present invention relates to the use of the simple gesture commands to replace complicated multiple-key input apparatus.

For achieving the foregoing goals, the present invention further relates to a touch-control lock system operated according to a gesture or a figure, comprises: a touch-control panel, having a plurality of touch-control points, for receiving a touch position by a user so as to output an electronic signal; a micro-control unit, for receiving the electronic signal and processing the electronic signal so as to obtain a true value and a touch sequence for the touch position; and a touch-control instruction processing unit, storing correct data for the gesture or the figure, and receiving the true value and the touch sequence so as to judge whether or not the true value to be a valid value, and comparing the touch sequence with the correct data so as to output a control command to an application apparatus.

For achieving the foregoing goals, the present invention further relates to a method for operating a touch-control lock system according to a gesture or a figure, comprising steps of: (a) sensing a designated gesture or figure while a user uses his finger touches a touch-control panel of the touch-control lock system and outputting an electronic signal according to the designated gesture or figure; (b) processing the electronic signal by a micro-control unit and judging whether or not the electronic signal is a valid input by the micro-control unit; (c) determining whether or not the designated gesture or figure is valid by the micro-control unit; (d) loading correct data for the designated gesture or figure stored in a touch-control instruction processing unit and comparing the correct data with the designated gesture so as to determine if the designated gesture or figure is valid; and (e) outputting a control command to an application apparatus to react correspondingly.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a functional block diagram of the touch-control lock operated by a gesture or a figure according to the present invention;

FIG. 2 is a structural view of the touch panel used in the present invention;

FIG. 3A˜F relates to the possible figures on the touch panel for the present invention; and

FIG. 4 relates to a flow chart of the method for operating the touch-control lock by using a gesture or a figure according to the present invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

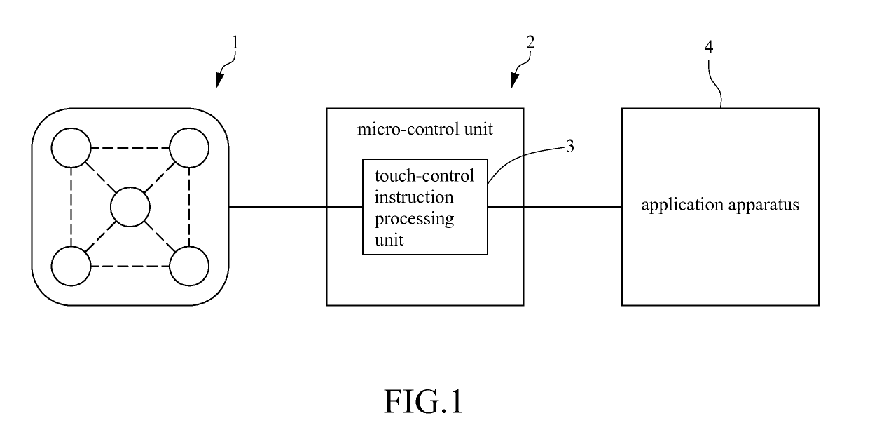

Referring to FIG. 1, which relates to a block diagram for the touch-control lock system operated according to a gesture or a figure, which comprises: a touch-control panel 1, has a plurality of touch-control points, for receiving a touch position by a user so as to output an electronic signal, wherein said touch-control panel 1 is in the resistive form or in the capacitive form; a micro-control unit 2, is receiving the electronic signal and processing the electronic signal so as to obtain a true value and a touch sequence for the touch position; and a touch-control instruction processing unit 3, which can be built inside the micro-control unit 2 and may comprise a storing device selected from the group consisting of a flash memory or an EEPROM (Electrically-erasable programmable read-only-memory), stores correct data for the gesture or the figure, and receives the true value and the touch sequence so as to judge whether or not the true value to be a valid value, and compares the touch sequence with the correct data so as to output a control command to an application apparatus 4, wherein the application apparatus 4 is selected from a group consisting of a computer, safety box, press-type electronic lock for residence or office, touch-control input instruction apparatus for an electronic toy, door-lock apparatus and the like. Meanwhile, when the control command can function as opening or closing a door if the inputted gesture or figure is correct. In the contrary, if the inputted gesture or figure is not correct, the control command can function for alarming or defense. The control command can be varied to serve different purposes according to the different application apparatus.

What is noteworthy is, the term “gesture” refers to, but not limited thereto, the actions such as single click, double click, drag, and the like, particularly on a mouse or on the panel. And the term “figure” refers to, but not limited thereto, any dragging tracks can made by the mouse. Furthermore, the touch sequence can be deemed as the gesture, the figure, or the combination of the gesture and the figure.

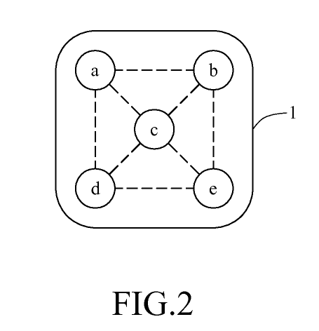

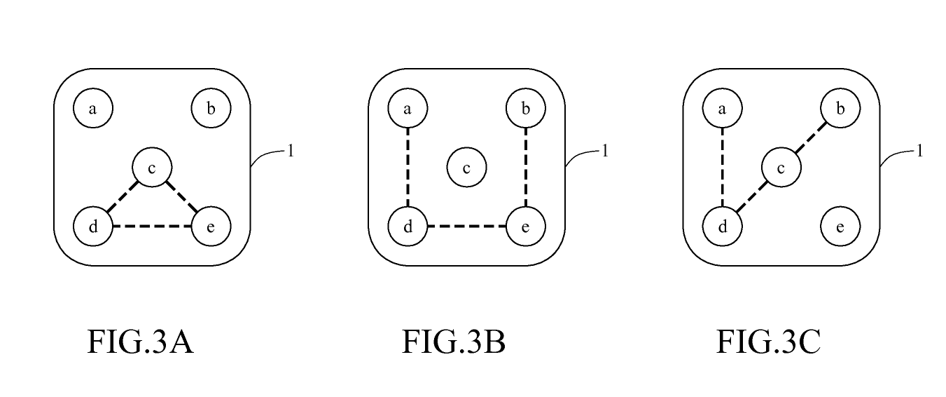

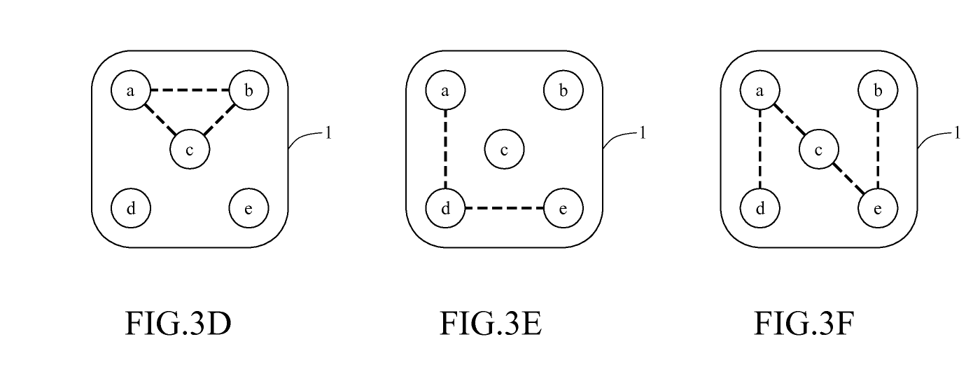

Please refer to FIG. 2, which relates to a structural diagram for the touch panel disclosed in the present invention, wherein the touch panel, in the present embodiment, has five touch control points, and their arrangement is for constructing a square by the exterior four touch control points and at the center of the exterior four touch control points there is installed another touch control point. The aforesaid five touch-control points (a,b,c,d,e), according to the different gestures or figure of the user, can form a plurality of variations. Please further refer to FIG. 3A˜F, which relates to the possibly plotted figures as recited in the touch panel of FIG. 2, exemplarily, FIG. 3A illustrates touch control point sequence (c,d,e) for a right triangle; and FIG. 3B illustrates touch control point sequence (a,b,d,e) for a “U” word; and FIG. 3C illustrates touch control point sequence (a,b,c,d) for a “V” word; and FIG. 3D illustrates touch control point sequence (a,b,c) for an inverted triangle; and FIG. 3E illustrates touch control point sequence (a,d,e) for an “L” word; and FIG. 3F illustrates touch control point sequence (a,c,d,e) as an “N” word. The aforementioned are only for example but not limited the scope of view thereto, as long as there are at least two touch control points on a touch panel (can be also rectangular arrangement), all of the possibly drawn gestures and figures are not depart from the scope of view of the present invention. In regard the drawn paths for multiple touch control points is also restricted, exemplarily, for three points (a,b,c), the possible correct path can be also set b as a starting point, c as a secondly consecutive point, and a as thirdly consecutive point, then an correct control command can be issued. Furthermore, the touch-controlled figure can be repeatedly drawn, for example, in FIG. 3A, the right triangle (c,d,c) should be drawn repeatedly for over three times then the correct control command can be issued, and it is also an applicable embodiment for the present invention.

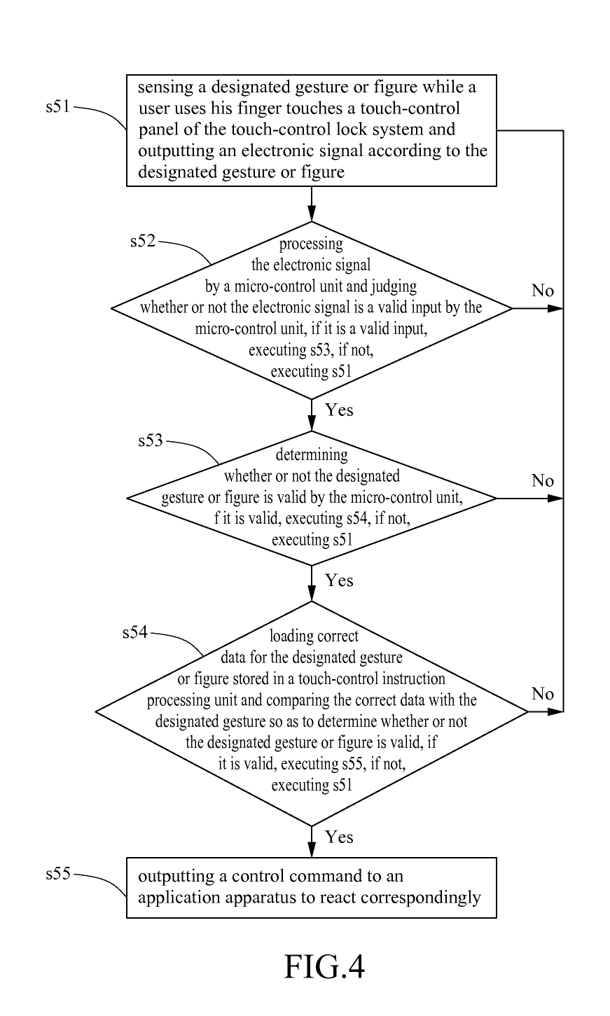

FIG. 4 illustrates the flow chart for the method for operating a touch-control lock system according to a gesture or a figure, comprising steps of: s51: sensing a designated gesture or figure while a user uses his finger touches a touch-control panel of the touch-control lock system and outputting an electronic signal according to the designated gesture or figure; s52: processing the electronic signal by a micro-control unit and judging whether or not the electronic signal is a valid input by the micro-control unit, if it is a valid input, executing s53, if not, executing s51; s53: determining whether or not the designated gesture or figure is valid by the micro-control unit, if it is valid, executing s54, if not, executing s51; s54: loading correct data for the designated gesture or figure stored in a touch-control instruction processing unit and comparing the correct data with the designated gesture or the figure so as to determine whether or not the designated gesture or figure is valid, if it is valid, executing s55, if not, executing s51; and s55: outputting a control command to an application apparatus to react correspondingly.

Preferably, the apparatus, which outputs the control command in s55, can be the micro control unit and the like.

According to the disclosure from FIG. 1˜FIG. 4, the skilled artisan can readily understood the touch-control lock installed at a computer for serving the security purpose at booting the computer. Only if the user correctly inputs the designated gesture or figure, then the lock can be unlocked. The user can easily remember the gesture or the figure to avoid his personal data being stolen. The technology content disclosed in the present disclosure can ensure the computer data security, and further provides an embodiment to replace conventional dial or key-press safety box lock, which ensures better security for the conventional safety box lock. Alternatively, the touch-control lock can serve the purpose for the touch-control input command apparatus for electronic toys such as electronic dogs, electronic dinosaurs, and electronic robots and exhibits superiors as easy and speedy input for commands. Also, it takes the advantage of the simple gesture commands to replace the complicated multi-key input apparatus. The aforementioned application enjoys a very high commercial value in the touch-control market. Thus, the present invention is filed to seek the patent right protection.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A touch-control lock system operated according to a gesture or a figure, comprising:
a touch-control panel, having a plurality of touch-control points, for receiving a touch position by a user so as to output an electronic signal;
a micro-control unit, for receiving the electronic signal and processing the electronic signal so as to obtain a true value and a touch sequence for the touch position; and
a touch-control instruction processing unit, storing correct data for the gesture or the figure, and receiving the true value and the touch sequence so as to judge whether or not the true value to be a valid value, and comparing the touch sequence with the correct data so as to output a control command to an application apparatus.

2. The touch-control lock system as recited in claim 1, wherein the touch-control instruction processing unit is built inside the micro-control unit.

3. The touch-control lock system as recited in claim 1, wherein the application apparatus is selected from a group consisting of a computer, safety box, press-type electronic lock for residence or office, touch-control input instruction apparatus for an electronic toy, door-lock apparatus and the like.

4. The touch-control lock system as recited in claim 1, wherein the touch-control instruction processing unit further comprises a storing device.

5. The touch-control lock system as recited in claim 4, wherein the storing device is a flash memory or a voltage-erasable programmable read-only memory.

6. The touch-control lock system as recited in claim 1, wherein the touch-control panel is resistive or capacitive.

7. A method for operating a touch-control lock system according to a gesture or a figure, comprising steps of:
(a) sensing a designated gesture or figure while a user uses his finger touches a touch-control panel of the touch-control lock system and outputting an electronic signal according to the designated gesture or figure;
(b) processing the electronic signal by a micro-control unit and judging whether or not the electronic signal is a valid input by the micro-control unit;
(c) determining whether or not the designated gesture or figure is valid by the micro-control unit;
(d) loading correct data for the designated gesture or figure stored in a touch-control instruction processing unit and comparing the correct data with the designated gesture/figure so as to determine if the designated gesture or figure is valid; and
(e) outputting a control command to an application apparatus to react correspondingly.

8. The method as recited in claim 7, wherein the control command is issued either by the micro-control unit or the touch-control instruction processing unit.

9. The method as recited in claim 7, wherein if in the step (b) the electronic signal is a valid input, then executing the step (c), and if in the step (b) the electronic signal is not a valid input, then executing the step (a).

10. The method as recited in claim 7, wherein if in the step (c) the designated gesture or figure is valid, then executing the step (d), and if in the step (c) the designated gesture or figure is not valid, then executing the step (a).

11. The method as recited in claim 7, wherein if in the step (d) the comparing result is correct, then executing the step (e), or executing the step (a).
